(19) United States
(12) Patent Application Publication
(10) Pub. No.: US 2007/0163892 A1
(43) Pub. Date: Jul. 19, 2007

(54) Corrosion sensor

(75) Inventor: Manoj Haridas, Bangalore (IN)

Correspondence Address: HONEYWELL INTERNATIONAL, INC.;Patent Services Group AB2, P.O. Box 2245, Morristown, NJ, 07962, US

(73) Assignee: Honeywell International, Inc., Morristown, NJ (US)

(21) Appl. No.: 11/332,235

(22) Filed: Jan. 17, 2006

(51) Int. Cl. G01N 17/04; G01N 27/26

(52) U.S. Cl. 205/776.5; 204/404

(57) ABSTRACT

A corrosion sensor having a fuse box having a plurality of corrosions fuses having different electrochemical activities, wherein the corrosion sensor is to monitor in-situ corrosion is discolsed. The corrosion sensor system having (a) a corrosion sensor having fuse box having a corrosion fuse having an eletrochemical activity, wherein the corrosion sensor is to monitor in-situ corrosion, and (b) an electronic module connected to the corrosion sensor for monitoring and storing potential and current data to allow for analysis of corrosion of the corrosion fuses is also disclosed. In addition, a method of monitoring corrosion by exposing a corrosion sensor having a corrosin fuse to an environment and determining a rate at which the corrosion fuse is corroded by the environment is disclosed.

### RELATED APPLICATIONS

None.

### FIELD OF INVENTION

The embodiments of the invention relate to a real-time corrosion sensor comprising a “fuse box” containing an array of “corrosion fuses.” The invention transcends several scientific disciplines such as analytical and molecular chemistry, optics, materials science, and medical or chemical diagnostics.

### BACKGROUND

Corrosion impacts almost all structures containing metals. For example, monuments of civilization (Statue of Liberty, London Tower bridge, Sydney Harbor bridge), ships, buildings, bridges and highways. In many such instances, it is impractical to set up onsite corrosion laboratories comprising “effect-measuring” equipment for corrosion measurement. Presently, corrosion conditions are quantified by exposing a test specimen (coupon) in the field for a certain time and measuring material degradation at a coordinating laboratory situated at a convenient location. As a result, no real-time corrosion sensing or measurement (qualitative or quantitative) is performed. Besides, the present protocols are additive (i.e., the effects add up on the test coupons over the duration of data collection) and as such it is very difficult to determine the most corrosive atmosphere to hit the specimen. In situations where corrosion conditions change quite dramatically and suddenly, the absence of a real-time corrosion sensing and recording mechanism is very significant.

Nearly all metals corrode continuously, including aluminum and copper. The protective oxide layer in aluminum is not sufficient to prevent pitting due to sea water or vapors. It is now well accepted that corrosion occurs from a unique combination of material susceptibility, corrosion conditions and mechanical stresses.

It is possible to select material properties and the material such that corrosion is minimized, but due to an inter-dependence among the above mentioned factors, variations in corrosion conditions can easily disrupt even the most rigorous materials provisions. For instance, on the basis of complex Pourbaix diagrams, tantalum is known to be one of the most corrosion resistant materials in the large pH regime of 2.0 to 14.0. However, tantalum corrodes quite readily by exposure to polymer electrolytes, such as polycarbonate resins that are totally non-ionic.

Another area of significant importance is pipeline corrosion. Just in the U.S., there are 1.2 million miles of natural gas distribution and transmission pipelines that crisscross the United States is essential to maintaining the Nation's natural gas supplies.

Pipeline corrosion results from water, condensation, scratches, or other actions that can damage a pipe's protective coating and sensitive joints. Like rust on a car, pipeline corrosion can extend far down into the metal, well beyond the visual signs on the surface. Detecting and measuring corrosion are essential to determine the strength and life expectancy of the pipe.

The traditional method for detecting pipeline corrosion requires excavation to expose a pitted section of pipe, sandblasting to remove all dirt and debris, then manual measurements by a technician using a hand-held gauge and bridging bar. Time-consuming and expensive, this method is also subject to the technician's interpretation.

It is hence significant to monitor corrosion conditions in real-time, as opposed to determining its cumulative effects. Such sensing protocol is particularly suited for field work and in developing a smart corrosion sensing service. The smart corrosion sensing service can be designed to take remedial action such as introducing a dose of stimulus neutralizing additives, or summoning a field engineer, or alerting law enforcement and other similar actions depending upon the severity of the situation.

### SUMMARY OF INVENTION

The embodiments of this invention relate to a corrosion sensor comprising a fuse box comprising a plurality of corrosions fuses having different electrochemical activities, wherein the corrosion sensor is to monitor in-situ corrosion. Preferably, the corrosion sensor is adapted to be embedded in or emplaced on a structure to be monitored. Preferably, the corrosion fuses are wires. Preferably, the wires comprise a material selected from the group consisting of K, Na, Ba, Mg, Al, Zn, Fe, Ni, Sn, Pb, Cu, Hg, Ag, Pt and Au. Preferably, the wires have a diameter in a range of about 1 micron to 1 cm. Preferably, the fuse box comprises a vacuum airlock chamber or a small hermetically sealed non-metallic enclosure wherein corrosion of the corrosion fuse is substantially zero.

Other embodiments of the invention relate to a corrosion sensor system comprising (a) a corrosion sensor comprising fuse box comprising a corrosion fuse having an electrochemical activity, wherein the corrosion sensor is to monitor in-situ corrosion, and (b) an electronic module connected to the corrosion sensor for monitoring and storing potential and current data to allow for analysis of corrosion of the corrosion fuses. Preferably, the corrosion fuse is disc-shaped. The corrosion sensor system could further comprise a reference module comprising a sealed corrosion fuse that is permanently sealed in a small hermetically sealed non-metallic enclosure wherein corrosion of the sealed corrosion fuse is substantially zero, and further wherein the electronic module is adapted to compare an amount of corrosion of the corrosion fuse versus that of the sealed corrosion fuse.

Yet other embodiments of the invention relate to a method comprising exposing a corrosion sensor comprising a corrosion fuse to an environment and determining a rate at which the corrosion fuse is corroded by the environment. Preferably, the determining a rate at which the corrosion fuse is corroded is performed by optical microscopy. Preferably, the determining a rate at which the corrosion fuse is corroded is performed by applying a voltage difference between two locations of the corrosion fuse. Preferably, the determining a rate at which the corrosion fuse is corroded is performed by electrochemical impedance spectroscopy. Preferably, the determining a rate at which the corrosion fuse is corroded comprises measuring a potential which corresponds to a polarization of the corrosion fuse and measuring a current flowing through the corrosion fuse, wherein the polarization and the measured current output together indicate an amount of corrosion of the corrosion fuse. Preferably, the corrosion sensor system further comprises comparing an amount of corrosion of the corrosion fuse versus that of a sealed corrosion fuse that is permanently sealed in a small hermetically sealed non-metallic enclosure wherein metal degradation is substantially zero. Further preferably, the corrosion sensor system further comprises applying the corrosion sensor to an area of a substrate and creating an image of the area showing portions that are corroded versus non-corroded portions.

As will be realized, this invention is capable of other and different embodiments, and its details are capable of modifications in various obvious respects, all without departing from this invention. Accordingly, the drawings and description are to be regarded as illustrative in nature and not as restrictive.

### DETAILED DESCRIPTION

As used in the specification and claims, the singular forms “a”, “an” and “the” include plural references unless the context clearly dictates otherwise.

The term “in-situ” refers to in the original or natural place or site. The term “to monitor in-situ” means to monitor a thing while leaving the thing in the original place or position and without substantially altering the position of the thing from its original position.

The term “corrosion” refers to a chemical (often electrochemical) process that destroys structural materials. Typically it refers to corrosion of metals, but any other material (e.g., plastic or semiconductor) will also corrode. The simplest example of metallic corrosion is the rusting of iron in air. Iron is spontaneously oxidized by the oxygen in air to iron oxides (while the oxygen is being reduced). Metallic corrosion is very often an electrochemical process. It is always electrochemical when the metal is immersed in a solution, but even in atmospheric corrosion a thin film of condensed moisture often covers the surface. The metal in the corrosive solution essentially acts as a short-circuited electronic cell. Different areas of the surface act as anode and cathode, at the anodic areas the metal is oxidized to an oxide while at the cathodic areas the dissolved oxygen is being reduced. The spontaneous complementary oxidation/reduction processes of “rusting” are spatially separated while an electrical current is flowing “internally” from one part of the corroding metal to another; the current is totally “wasted” as it produces no useful work but only generates heat. (A cell arrangement like this is often called a “local cell.”) Corrosion products are typically oxides, but other products (e.g., sulfides) can also form depending on the environment. Corrosion always involves oxidation of the corroding material in the general sense of the term.

An “electrochemical series” is a tabulation on which various substances, such as metals or elements, are listed according to their chemical reactivity or standard electrode potential. It is usually ordered with increasing standard electrode potentials (most negative on top). For metals, the order indicates the tendency to spontaneously reduce the ions of any other metal below it in the series. During electrolytic (i.e., a process that decomposes a chemical compound into its elements or produces a new compound by the action of an electrical current) reduction of cations (i.e., positively charged ions, as compared to anions, which are negatively charged ions) an element lower in the series (more positive) will deposit first, and an element higher in the series (more negative) will deposit only when the solution is practically depleted of the ions of the first element. Also called “electrochemical series” and “galvanic series.”

An “element” is a substance that cannot be decomposed into simpler substances by chemical means.

The term “oxidation” means losing electron to oxidize. The term “reduction” means gaining electrons to reduce. The term “redox reaction” refers to any chemical reaction which involves oxidation and reduction. All electron-transfer reactions, i.e., chemical reaction where an electrical charge (usually an electron) is transferred from one reactant to another, are considered oxidation/reduction. The substance gaining electrons (“oxidizing agent” or “oxidant”) is oxidizing the substance that is losing electrons (“reducing agent” or “reductant”). In the process, the “oxidizing agent” is itself reduced by the “reducing agent.” Consequently, the reduction process is sometimes called “electronation,” and the oxidation process is called “de-electronation.”

The “standard electrode potential” is equilibrium potential (i.e., the electrical potential of an electrode measured against a reference electrode when there is no current flowing trough the electrode) of an electrode when both the oxidized and the reduced species are present in unit concentration (strictly speaking, activity) in the solution; if the “reduced” form is a metal, a pure metal (not alloyed with other metals) is considered to be at unit concentration. The standard potentials are always expressed against the standard hydrogen electrode the potential of which is substantially zero “by definition.” Standard potentials are a function of the temperature, they are usually tabulated for 25° C. Also called “normal electrode potential.” The standard potential is the electromotive force of an electrochemical cell (i.e., A device that converts chemical energy into electrical energy or vice versa when a chemical reaction is occurring in the cell) comprised of the electrode in question and the standard hydrogen electrode. Strictly speaking, one must use unit activities rather than concentrations.

An “electrode” an electronically conducting part of an electrochemical cell. It can be an anode or a cathode. It can be a simple metallic structure (rods, sheets, etc) or much more complicated, composite structures.

The term “polarization” refers to a change of potential of an electrode from its equilibrium potential upon the application of a current.

The term “corrosion fuse” refers to a metal part, e.g., a wire of a known dimension, comprising a metal from the electrochemical activity series.

The term “fuse box” refers to a housing for an array of corrosion fuses.

The embodiments of the real-time corrosion sensor operates as follows: The embodiments of the invention provide a “fuse box” containing an array of “corrosion fuses”. Each corrosion fuse typically comprises a wire of known dimensions wherein the wire is chosen from the electrochemical activity series that is known to corrosion engineers. The series may be summarized as: K, Na, Ba, Mg, Al, Zn, Fe, Ni, Sn, Pb, (H), Cu, Hg, Ag, Pt, Au. The wires could have a diameter in the range from about 1 micron to 1 cm, preferably in the range from about 5 microns to 0.5 cm, more preferably in the range from about 10 microns to 0.25 cm, and most preferably in the range from about 25 microns to 0.1 cm.

The corrosion sensor array could comprise individual corrosion fuses for measuring various elements and ions, such as chloride, sulfide, copper, hydrogen (pH), etc. and elements for evaluating the instantaneous corrosion properties of structural materials. The exact combination and number of elements measured or monitored could depend upon the environmental conditions and materials used which are subject to corrosive effects. Such a corrosion monitoring system embedded in or mounted on a structure exposed to the environment could serve as an early warning system for the onset of severe corrosion problems for the structure, thus providing a safety factor as well as economic factors The sensor array could be accessed to an electronics/computational system, which could provide a means for data collection and analysis.

The electrochemical activity series and the interplay and distinction among its elemental members provides the necessary graduation and calibration of a corrosive environment response. The intensity of a corrosive environment is determined from real-time observation of corrosion on each of the test fuses. Depending upon the situation, the first wire comprises K, the second comprises Na and so on.

The fuse box is exposed to the test environment for a fixed duration (thin wires for short tests, thicker wires for longer tests) and the rate at which the wires are etched or oxidized by the surroundings is determined from light microscopy (or a magnifier viewing window against an enlarged graph paper background, or a reflectance beam to penetrate the smooth surface oxide layers e.g. aluminum). Alternatively, the rate at which the wires are etched or oxidized by the surrounding can be determined by measuring the impedance of the corrosion fuses, i.e., by electrochemical impedance spectroscopy (EIS). In most measurements, the test series can begin from zinc onwards and truncate at say, thin gold (or gold alloy).

EIS uses very small excitation voltages, generally in the range of 5 to 10 mV peak-to-peak, through the corrosion fuse which forms an electrochemical cell. The current induced by this voltage is measured and an impedance determined as a function of frequency. EIS is based on the fact that the behavior of an electrochemical cell and that of an electronic circuit are analogous. This allows equivalent circuit modeling of a given electrochemical cell. Fundamental AC circuit theory can then be applied to the circuit model and the results accurately correlated to reveal physical and chemical properties of the electrochemical cell. In the electrochemical cell having the corrosion fuse, the presence of a corrosion environment surrounding the corrosion fuse act to change the impedance of the corrosion fuse, which can be modeled as a resistor, a capacitor, an inductor or a combination of elements.

Performing EIS on a corrosion fuse involves applying ac voltage of varying frequencies through the corrosion fuse which is immersed in a corrosive environment such as a conductive electrolyte. The current or impedance (magnitude and phase) is measured between the two ends of the corrosion fuse.

Prior to exposure of the corrosion fuses to a corrosion environment, the corrosion fuses are maintained in their pristine state by storing them in a small vacuum airlock chamber where metal degradation is substantially zero. During corrosion testing, the corrosion fuses are exposed to the corrosive environment only when environmental sampling is truly representative. The fuse box can be left open to suit dynamic measurement or kept sealed to demonstrate data offsite. In either case, a sample of the corrosive environment is let into the fuse box containing the corrosion fuses using an assembly arrangement that provides substantially the same temperature and substantially the same pressure inside the fuse box as that existing outside the fuse box.

As the fuse box is filled with the sample of the corrosive environment, the corrosion fuse would undergo a rapid polarization change, from levels near that when there is substantially zero corrosion of the corrosion fuse to values approaching the maximum potential under the corrosive environment. The polarization change values of the corrosion fuse indicate whether minimal or no deterioration of the corrosion fuse has occurred, whether little or more corrosion damage can proceed, and whether the corrosive environment requires oversight and maintenance.

Since the thermal expansion coefficient of each material is known and also the test temperature, an algorithm correlating the change in dimensions at higher temperature and etching rates can be developed. The sensitivity can be very high and can be used to quantify corrosion differences, for example, from one sea water having 27000 ppm of chlorides to another sea water having 35000 ppm of chlorides, by varying the measurement times. For greater sensitivity, higher surface area disks may be used instead of wires. The stage can be motorized to simulate turbulence and wind flow over the corrosion fuse.

The corrosion sensor of the embodiments of this invention could be conformable sensors that could conform according to the shape of an object such as the boundary of the gas pipe to measure pitting and deterioration of natural gas pipelines. The conformable corrosion sensor could be bonded to the gas pipeline, generally on the exterior surface, and connected to computer for automated measuring of pipeline corrosion. The corrosion sensor could be used with the pipeline exposed or lying buried, and it does not require sandblasting, which is a substantial improvement over conventional corrosion sensor by reducing cost and the time involved in the investigation. Furthermore, because the method could be automated, it eliminates individual interpretation and improves accuracy.

The flexible, conformable corrosion sensor could be designed to conform to the contours of the pipe. The corrosion sensor of the embodiments of the invention would be generally rugged enough for field use. The corrosion sensor could be applied to a exterior or interior surface area of a pipe, and the corrosion sensor could take an image of the overlaid area showing portions that are corroded versus non-corroded portions. Thus, the corrosion sensor of this invention could be used to determine portions of an area having a pure metal (M) and portions having an oxidized metal (MO). The corrosion sensor could then be moved to a different area, and new corrosion images taken, until a picture of a desired area of the pipe has been created.

The data could be transmitted to a computer in real time through a cable attached to corrosion sensor. The computer could form a composite image of corrosion from the individual snapshots of different overlaid areas, and analyze the extent of corrosion of the pipe.

The sensor of this invention could also be used for aerospace/airline testing to determine Al corrosion where the need is more for creating an areal map of corroded areas in addition to or rather than determining unknown chemical species in low concentration.

For highest accuracy and sensitivity, the corrosion sensor of the embodiments of the invention generally has one-time use capabilities. In another embodiment, the corrosion sensor has multiple use capabilities wherein the exposed corrosion fuses, e.g., test wires, from a previous run are placed into the vacuum airlock chamber and a morphological record of the oxidized profile of each test wire is stored in an archives. At the time of next usage, the test wires are brought out of the vacuum airlock chamber and subjected to environmental testing by considering the archived data points as the starting points for the new observation. In this mode, the embodiments of the invention perform a cumulative corrosion sensing function.

By virtue of its electrochemical design, the corrosion sensor, intended for aqueous and vapor-assisted corrosion sensing could be designed to perform satisfactorily to test bio-corrosion or embrittlement, particularly when secondary corrosion mechanisms, i.e., corrosion mechanisms other than electrochemical corrosion, do not account for more that about 10% of the total extent of corrosion. The embodiments of the corrosion sensor of the invention could be used for testing electrochemical corrosion where there is a continuous need to estimate corrosive heats so as to anticipate and plan maintenance or preventive action.

The embodiments of the corrosion sensor of this invention is thus capable of determining corrosion in real-time (i.e., as it occurs) and can initiate remedial measures when corrosion activity exceeds a critical threshold. The corrosion sensor is also capable of identifying the “maximum extent of corrosion” recorded at a particular location, and particularly suited for field-work. In addition, the corrosion sensor could have smart sensing capabilities that can be integrated and modified to suit particular environments and situations.

In other embodiments, the smart corrosion sensing service can be designed to take remedial action such as introducing a dose of stimulus neutralizing additives, or summon a field engineer, or alerting law enforcement and other similar actions depending upon the severity of corrosion incident. i.e. in the unexpected corrosion of a lower activity test fuse.

While only certain features of the invention have been illustrated and described herein, many modifications and changes will occur to those skilled in the art. It is, therefore, to be understood that the appended claims are intended to cover all such modifications and changes as fall within the true spirit of the invention.

The sensor could also be used for testing corrosion resistance and for determining the proper environment for materials development, i.e., nanomaterials, battery energy storage, electroplating, low voltage phosphorescence, superconductivity, epitaxial lattice matching, or chemical catalysis.

This application discloses several numerical range limitations that support any range within the disclosed numerical ranges even though a precise range limitation is not stated verbatim in the specification because the embodiments of the invention could be practiced throughout the disclosed numerical ranges. Finally, the entire disclosure of the patents and publications referred in this application, if any, are hereby incorporated herein in entirety by reference.

1. A corrosion sensor comprising a fuse box comprising a plurality of corrosions fuses having different electrochemical activities, wherein said corrosion sensor is to monitor in-situ corrosion.

2. The corrosion sensor of claim 1, wherein the corrosion sensor is adapted to be embedded in or emplaced on a structure to be monitored.

3. The corrosion sensor of claim 1, wherein the corrosion fuses are wires.

4. The corrosion sensor of claim 3, wherein the wires comprise a material selected from the group consisting of K, Na, Ba, Mg, Al, Zn, Fe, Ni, Sn, Pb, Cu, Hg, Ag, Pt and Au.

5. The corrosion sensor of claim 3, wherein the wires have a diameter in a range of about 1 micron to 1 cm.

6. The corrosion sensor of claim 1, wherein the fuse box comprises a vacuum airlock chamber or a small hermetically sealed non-metallic enclosure wherein corrosion of the corrosion fuse is substantially zero.

7. A corrosion sensor system comprising (a) a corrosion sensor comprising fuse box comprising a corrosion fuse having an electrochemical activity, wherein the corrosion sensor is to monitor in-situ corrosion, and (b) an electronic module connected to the corrosion sensor for monitoring and storing potential and current data to allow for analysis of corrosion of the corrosion fuses.

8. The corrosion sensor system of claim 7, wherein the corrosion sensor is adapted to be embedded in or emplaced on a structure to be monitored.

9. The corrosion sensor system of claim 7, wherein the corrosion fuse is a wire.

10. The corrosion sensor system of claim 9, wherein the wire comprises a material selected from the group consisting of K, Na, Ba, Mg, Al, Zn, Fe, Ni, Sn, Pb, Cu, Hg, Ag, Pt and Au.

11. The corrosion sensor system of claim 7, wherein the corrosion fuse is disc-shaped.

12. The corrosion sensor system of claim 7, wherein the fuse box comprises a vacuum airlock chamber or a small hermetically sealed non-metallic enclosure wherein corrosion of the corrosion fuse is substantially zero.

13. The corrosion sensor system of claim 7, further comprising a reference module comprising a sealed corrosion fuse that is permanently sealed in a small hermetically sealed non-metallic enclosure wherein corrosion of the sealed corrosion fuse is substantially zero, and further wherein the electronic module is adapted to compare an amount of corrosion of the corrosion fuse versus that of the sealed corrosion fuse.

14. A method comprising exposing a corrosion sensor comprising a corrosion fuse to an environment and determining a rate at which the corrosion fuse is corroded by the environment.

15. The method of claim 14, wherein the determining a rate at which the corrosion fuse is corroded is performed by optical microscopy.

16. The method of claim 14, wherein the determining a rate at which the corrosion fuse is corroded is performed by applying a voltage difference between two locations of the corrosion fuse.

17. The method of claims 14, wherein the determining a rate at which the corrosion fuse is corroded is performed by electrochemical impedance spectroscopy.

18. The method of claim 14, wherein the determining a rate at which the corrosion fuse is corroded comprises measuring a potential which corresponds to a polarization of the corrosion fuse and measuring a current flowing through the corrosion fuse, wherein the polarization and the measured current output together indicate an amount of corrosion of the corrosion fuse.

19. The method of claim 14, further comprising comparing an amount of corrosion of the corrosion fuse versus that of a sealed corrosion fuse that is permanently sealed in a small hermetically sealed non-metallic enclosure wherein metal degradation is substantially zero.

20. The method of claim 14, further comprising applying the corrosion sensor to an area of a substrate and creating an image of the area showing portions that are corroded versus non-corroded portions.
